(19) United States
(12) Patent Application Publication
(10) Pub. No.: US 2015/0245726 A1
(43) Pub. Date: Sep. 3, 2015

(54) CITRUS JUICER

(71) Applicant: Robinson Home Products Inc., Williamsville, NY (US)

(72) Inventors: Lou Henry, Scarsdale, NY (US); John Healy, Brooklyn, NY (US)

(73) Assignee: Robinson Home Products Inc., Williamsville, NY (US)

(21) Appl. No.: 14/193,998

(22) Filed: Feb. 28, 2014

(51) Int. Cl. A47J 19/02; B26B 11/00; A47J 43/28

(52) U.S. Cl. CPC A47J 19/022; A47J 43/288; B26B 11/00

(57) ABSTRACT

A juicer comprising a reamer having a blade receiving aperture and a knife having a knife blade and a knife handle so that at least a portion of the knife blade may be received in the blade receiving aperture of the reamer. First and second cooperating elements releasably retain the knife and reamer in a fixed relationship.

### FIELD OF THE INVENTION

The present invention relates to a manual, hand held kitchen device, and more specifically to a manual, hand held kitchen device for juicing citrus fruits such as oranges, grapefruits, lemons and limes.

### BACKGROUND OF THE INVENTION

Many people enjoy citrus juices in the morning with breakfast, as a regular daily drink and for use as ingredients in food recipes or as mixers in cocktails. This can be traced to the importance of nutrients found in citrus products for our daily dietary needs as well as the well-liked taste of citrus juices. Moreover, it is widely known that freshly prepared, or “fresh squeezed”, citrus juices taste the best and provide the most nutrients.

To make the preparation of “fresh squeezed” citrus juices easier, a variety of citrus knives and juicers have been developed. In preparation for juicing, the citrus fruit is generally cut in half using a sharp knife, to create a half citrus fruit. The half citrus fruit is then processed on one of a variety of known juicers to extract the juice, and generally some pulp, from the citrus fruit rind.

Known juicers include stationary manual juicers, such as a reamer is placed on the center of a bowl for a user to push down and twist a half citrus fruit with the juice caught in the bowl and manual citrus presses, where a half citrus fruit is placed on a reamer and a lever is manually pulled down to squeeze the fruit on the reamer with the juice caught in a bowl or funnel directed to a container. Known juicers also include electric juicers, where a half citrus fruit is placed on a reamer that spins using an electric motor to extract the juice from the fruit and direct it into a glass or other container.

However, stationary and electric juicers are generally large, taking up valuable space in kitchen cabinets, require a fair amount of cleaning after use and can be awkward to operate. Therefore, they are not well suited to a small kitchen or to limited uses, where a single citrus fruit is being juiced for a small serving or where only a small amount of juice is needed, i.e., a half of a lime for a recipe or cocktail.

In keeping, hand held reamers have been developed to more efficiently juice smaller amounts of citrus. With hand held reamers, a reamer at the end of a handle held in one hand of a user is pressed it into a half citrus fruit held in the user's other hand.

Of course, even when only a small amount of juice is needed, the citrus fruit is also used for garnishes. This includes not only a slice of the citrus fruit to garnish the side of a glass or to place on a dish, but also the use of shavings of the rind, each of which requires the use of a sharp knife, similar to the one used to create a half citrus fruit.

Based on the known prior art, it is clear that a more efficient kitchen device having the tools needed to halve and juice a half citrus fruit as well as prepare citrus garnishes would advance the art.

### SUMMARY OF THE INVENTION

Deficiencies in the prior art are addressed by the present invention, which is directed to a hand held juicer comprising a reamer having reamer body with a work end and a handle end, a blade receiving aperture on the handle end and a first cooperating retaining element, and a knife having a knife blade, a handle and a second cooperating retaining element, wherein at least a portion of the knife blade is received in the blade receiving aperture and the first and second cooperating retaining elements cooperate to releasably retain the knife and reamer in a fixed relationship.

Although the present invention contemplates the use of the knife handle as the reamer handle, the reamer can have a separate handle permanently affixed to the handle end of the reamer. More particularly, the reamer may also include a hollow handle which is unitarily formed with or permanently affixed to the reamer body. The hollow handle is designed to receive the knife handle as the knife blade is received in the blade receiving aperture, most preferably having an inward facing surface sized and shaped to mate with an outer facing surface of the knife handle.

Although not necessary to the present invention, the hollow handle provides a more secure grasp on the reamer than when the knife handle is also used as the reamer handle.

The first and second cooperating retaining elements can comprise any suitable cooperating elements to retain the knife and reamer in a fixed relationship. For example, one or more bayonet locks, screw threads, clamps, clips, pins, snap together members, detents and receiving depressions, magnets, clasps, frictional contact surfaces and combinations thereof can be used. Most preferred however, are snap fit bayonet locks, where cooperating bayonet members engage by rotating the knife handle with relation to the reamer and a detent snap fits into a corresponding depression when the knife handle has been fully rotated.

The invention therefore maintains the knife in ready relation to the reamer, so that the user can cut and prepare citrus fruits. Preferably, the knife blade is serrated to assist the cutting of the citrus fruit, but this is not necessary to the purpose of the invention. Moreover, the blade may be composed of any suitable material, including metal or ceramic, with food grade stainless steel being most preferred.

It is also preferred that the knife handle include a hang hole, to permit the juicer to be suspended on a hook when not in use. Although the hang hole can be included as a ring on the terminal end of the handle, it is preferred that the hang hole be molded into the knife handle.

The reamer may be any size and shape for use in extracting juice and pulp from a citrus fruit. The preferred reamer, however, employs a generally conical reamer body where the conical section is arcuate from the work end to the handle end. The outer surface of the reamer is preferably textured, with any suitable texture pattern for aiding in the crushing and removal of the juice and pulp from the citrus fruit rind. Most preferably, the outer surface of the reamer body comprises a series of peaks and valleys running in the direction of the reamer body from the handle end to the work end about the circumference of the reamer body.

The design of the kitchen device allows the juicer component to be held comfortably and at the optimal angle of penetration, for the user to advance and rotate the work end of the reamer in the citrus fruit, thereby extracting the maximum amount of juice and pulp. This leads to a more efficient juicer, as well as a way to share space for multiple kitchen devices.

### BRIEF DESCRIPTION OF THE DRAWINGS

The present invention will be better understood when considered in view of the attached drawings, in which like reference characters indicate like parts. The drawings, however, are presented merely to illustrate the preferred embodiment of the invention without limiting the invention in any manner whatsoever.

FIG. 1 is an exploded perspective view of a first embodiment of the juicer of the present invention.

FIG. 2 is a perspective view of the first embodiment of the juicer in its fixed relationship.

FIG. 3 is an exploded perspective view of a second embodiment of the juicer of the present invention.

FIG. 4 is a side elevation of the second embodiment of the juicer in its fixed relationship.

FIG. 5 is a plan view of the hollow handle, looking down into the blade receiving aperture of the reamer.

### DETAILED DESCRIPTION OF THE PREFERRED EMBODIMENT

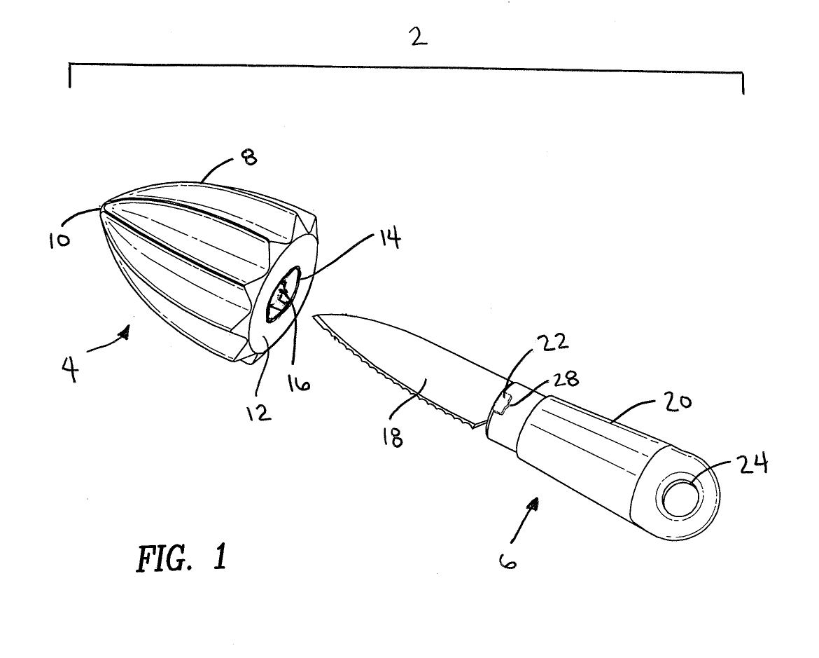

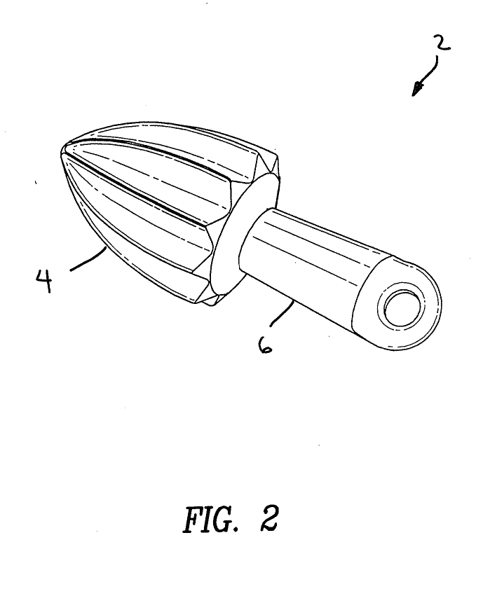

In one embodiment, shown in accompanying FIGS. 1 and 2, the juicer 2 comprises a reamer 4 and a knife 6 that can be separated for independent use of the knife 6 or retained in fixed relationship.

The reamer 4 includes a reamer body 8 with a work end 10, a handle end 12 and a textured outer surface, as well as a blade receiving aperture 14 and a first cooperating retaining element 16 surrounding the blade receiving aperture 14 at the handle end. The knife 6 includes a knife blade 18, a handle 20 and a second cooperating retaining element 22 on the end of the handle 20 adjacent the knife blade 18.

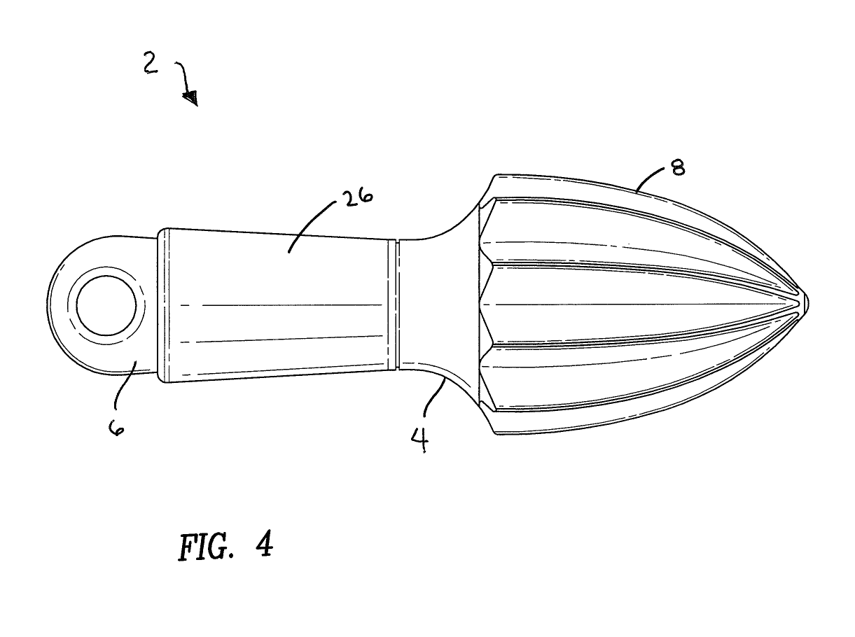

The knife 6 is replaceably removable from the reamer 4 so that the knife 6 can be used to cut the citrus fruit in half prior to juicing or for preparing citrus fruit garnishes such as slices or rind shavings. When in its fixed relationship, however, as shown in FIGS. 2 and 4, the knife blade 18 is received in the reamer blade receiving aperture 14 and the first and second cooperating retaining elements 16 and 22 cooperate to releasably retain the reamer 4 and knife 6 in a fixed relationship.

As shown in the drawings, the preferred reamer body 8 employs a generally conical shape that is arcuate from the work end 10 to the handle end 12. The outer surface of the reamer body 8 is textured with a series of peaks and valleys running in the direction from the work end 10 to the handle end 12 about the circumference of the reamer body 8. Of course, any suitable texture pattern for aiding in the crushing and removal of the juice and pulp from the citrus fruit rind may be used on the outer surface of the reamer body 8.

The knife blade 18 may be straight, however, a serrated blade is preferably used to assist the cutting of the citrus fruit. The knife handle 20 preferably includes a hang hole 24, to permit the juicer 2 to be suspended on a hook when not in use.

The first and second cooperating retaining elements 16 and 22 can comprise any suitable cooperating elements to retain the knife 6 and reamer 4 in a fixed relationship. For example, one or more bayonet locks, screw threads, clamps, clips, pins, snap together members, detents and receiving depressions, magnets, clasps, frictional contact surfaces and combinations thereof can be used.

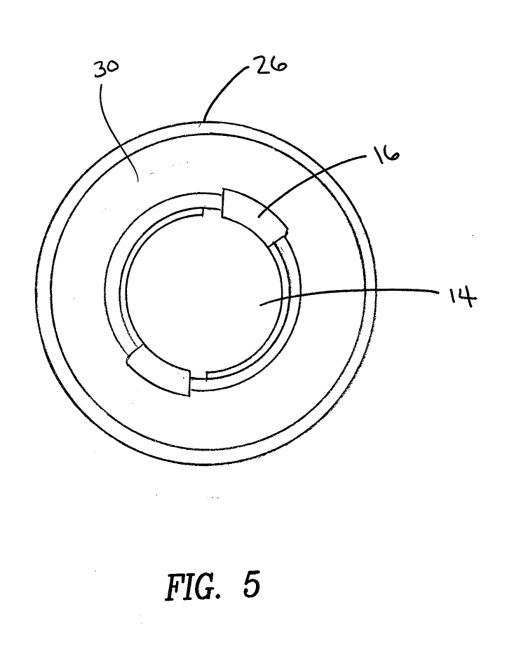

As shown in FIG. 5, however, the most preferred embodiment comprises snap fit bayonet locks, where outwardly ending tabs 22 on the knife handle 20 are rotated to engage catches 16 on the reamer 4 in a bayonet-type fashion. Detents 28 may be used to snap into receiving depressions (not shown) when the knife 6 has been fully rotated into the fixed position, to avoid inadvertent removal of the knife 6 from the reamer 4.

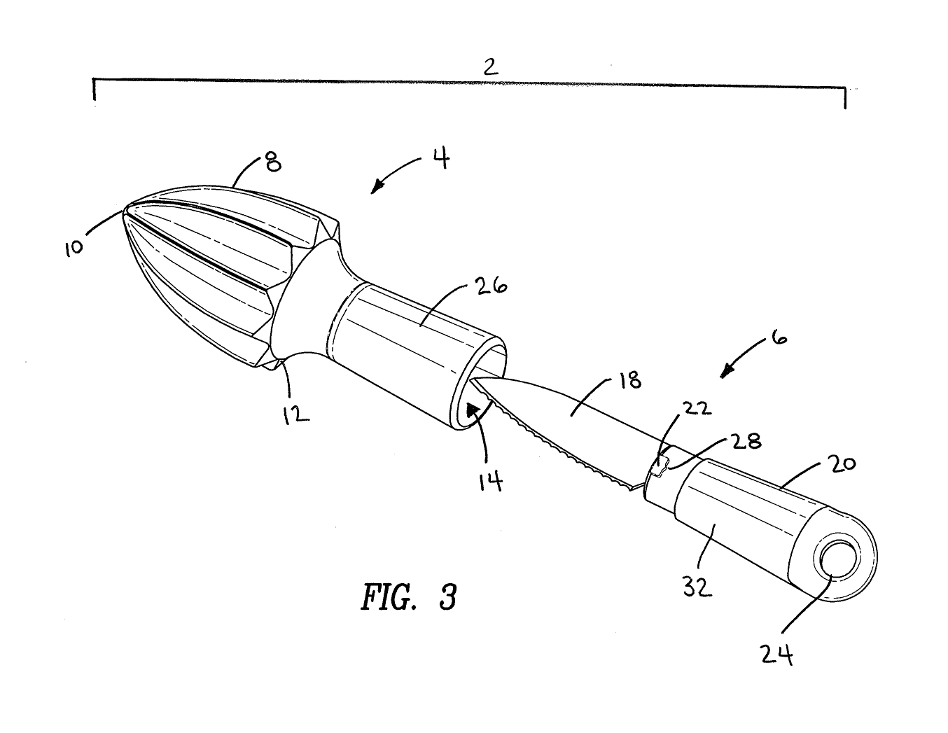

In the most preferred embodiment of the juicer 2 shown in FIGS. 3 to 5, the reamer 4 has a permanently affixed hollow handle 26 for the user to grasp when manipulating the reamer 4. The hollow portion of the hollow handle 26 has an inward facing surface 30 that is sized and shaped to mate with the outer facing surface 32 of the knife handle 20. Such sizing provides that the knife handle 20 is securely received in the hollow handle 26 to further avoid unintentional removal of the knife 6 from the reamer 4.

In the most preferred embodiments, the reamer 4, including the reamer body 8 and the hollow handle 26 (when used), as well as the knife handle 20, are formed of a rigid plastic material such as an acrylonitrile butadiene styrene (ABS) plastic. The knife blade 18 is preferably formed of a food grade stainless steel, however, suitable metals or ceramic blades may be incorporated into the present invention.

Variations, modifications and alterations to the above detailed description will be apparent to those skilled in the art. All such variations, modifications and/or alternatives are intended to fall within the scope of the present invention, limited only by the appended claims. All cited patents and publications are hereby incorporated by reference.

We claim:

1. A juicer comprising:
a reamer having reamer body with a work end and a handle end, a blade receiving aperture on the handle end and a first cooperating retaining element; and
a knife having a knife blade, a handle and a second cooperating retaining element,
wherein at least a portion of the knife blade is received in the blade receiving aperture and the first and second cooperating retaining elements cooperate to releasably retain the knife and reamer in a fixed relationship

2. The juicer of claim 1 wherein the reamer further comprises a hollow handle.

3. The juicer of claim 2 wherein the hollow handle is unitarily formed with or permanently affixed to the reamer body for manipulating the juicer.

4. The juicer of claim 2 wherein the hallow handle has an inward facing surface which mates with an outward facing surface on the knife handle.

5. The juicer of claim 1 wherein the first and second cooperating retaining elements are taken from the group consisting of bayonet locks, screw threads, clamps, clips, pins, snap together members, detents and depressions, magnets, clasps, frictional contact surfaces and combinations thereof.

6. The juicer of claim 1 wherein the first and second cooperating retaining elements comprise one or more bayonet locks, where cooperating bayonet members engage by rotating the knife handle with relation to the reamer.

7. The juicer of claim 6 wherein the first and second cooperating retaining elements further comprise one or more depressions that receive a detent when the knife handle has been fully rotated with relation to the reamer.

8. The juicer of claim 1 wherein the reamer body is substantially conical with a generally arcuate profile along a portion of the profile from the work end to the handle end.

9. The juicer of claim 1 wherein the reamer body has a textured outer surface.

10. The juicer of claim 9 wherein the textured outer surface comprises a series of peaks and valleys running in the direction of the reamer body from the handle end to the work end about the circumference of the reamer body.

11. The juicer of claim 1 wherein the knife handle comprises a hang hole at a terminal end.

12. The juicer of claim 1 wherein the reamer body and the knife handle are formed of an acrylonitrile butadiene styrene material.

13. The juicer of claim 1 wherein the knife blade is serrated.

14. The juicer of claim 1 wherein the knife blade is stainless steel.
